(19) United States
(12) Patent Application Publication
(10) Pub. No.: US 2021/0073909 A1
(43) Pub. Date: Mar. 11, 2021

(54) SYSTEM AND METHOD FOR AUTONOMOUS, INTELLIGENT, AND TUNABLE COMPARTMENTALIZATION OF MONETARY TRANSACTIONS

(71) Applicant: Envel, Inc., Boston, MA (US)

(72) Inventor: Stephen Nicholas Tebbs LE ROUX, London (GB)

(21) Appl. No.: 17/016,336

(22) Filed: Sep. 9, 2020

Related U.S. Application Data
(60) Provisional application No. 62/897,475, filed on Sep. 9, 2019.

(51) Int. Cl. G06Q 40/02; G06Q 20/40; G06N 20/00; G06K 9/62

(52) U.S. Cl. CPC G06Q 40/025; G06Q 20/401; G06K 9/6267; G06K 9/6256; G06N 20/00

(57) ABSTRACT

A system and method of compartmentalizing a monetary transaction into at least one of a plurality of electronic envelopes of an account. The method includes: generating at least one trained machine learning (ML) model by training at least one ML model with training data; receiving an indication of a deposit into a bank account of a user; in response to the indication, generating a ML model output by executing one or more of the at least one trained ML model, wherein the ML model output is used to determine an electronic envelope distribution; allocating the amount of the deposit into the at least one electronic envelope of the plurality of electronic envelopes based on the electronic envelope distribution; and sending electronic envelope account information to a client application that is configured to visually display a balance of the at least one electronic envelope based on the electronic envelope account information.

### CROSS-REFERENCE TO RELATED APPLICATIONS

This application claims the benefit of U.S. Provisional Application Ser. No. 62/897,475 filed on Sep. 9, 2019, which is hereby incorporated by reference in its entirety.

### TECHNICAL FIELD

This invention relates to methods and systems for AI-driven personal financial management of money and, more particularly, to autonomously assisted banking using machine learning (ML).

### BACKGROUND

There are many electronic platforms that are usable for managing monies or funds of an individual, including those provided by banks or other financial institutions. Such electronic platforms typically provide a user interface that allows a user to digitally access information relating to a bank or other financial account (collectively, referred to herein as a “bank account”), including account balances and transactional history. Some more-recent platforms allow a user to manually mark or label funds for certain purposes, such as for particular goals the user may have. Additionally, one such platform implements a feature that is used to calculate a portion of a bank account that is deemed to be financially prudent to be spent by a user. This calculation is based on a hard-coded equation that takes the account balance total and subtracts recurring expenses and other user-set goals so as to yield an amount that is considered acceptable to be spent by the user. Planning how to split up incoming money (e.g., deposits, transfers, or other monetary transactions in which money is moved or transacted into an account) into these accounts is therefore challenging. Further, if circumstances temporarily change, such as a high incoming bill, then, to account for such a high bill, the user must manually modify the splitting of incoming money. Therefore, maintaining and tracking such accounts requires large efforts. Additionally, current banking applications provide limited methods for incentivizing users to build wealth. One such example is automatic transference of funds above a certain fixed value into savings. However, a user's financial health is not amenable to being simplified to hard-coded rules as each user's finances are unique and change over time.

### SUMMARY

According to one aspect of the invention, there is provided a method of compartmentalizing a monetary transaction into at least one of a plurality of electronic envelopes of an account. The method includes: generating at least one trained machine learning (ML) model by training at least one ML model with training data; receiving an indication of a deposit into a bank account of a user; in response to receiving the indication of the deposit into the bank account, generating a ML model output by executing one or more of the at least one trained ML model, wherein the ML model output is used to determine an electronic envelope distribution to be applied to an amount of the deposit; allocating the amount of the deposit into the at least one electronic envelope of the plurality of electronic envelopes based on the electronic envelope distribution; and sending electronic envelope account information to a client application that is executed on a client device, wherein the client application is configured to visually display the electronic envelope account information on the client device, and wherein the electronic envelope account information indicates a balance of each of the at least one electronic envelope after having allocated the amount of the deposit.

According to various embodiments, the method may further include any one of the following features or any technically feasible combination of some or all of the features:
a first one of the at least one ML model is trained using time series data that corresponds to transactional data of a plurality of users;
the at least one ML model includes a first ML model and a second ML model, and wherein the generating step includes training the first ML model and the second ML model to obtain a first trained ML model and a second trained ML model;
the first ML model is a ML classification model that is generated based on merchant information that is associated with transactional data of the user of the client device, and wherein the ML classification model is used to generate supplemented training data used to train the second ML model;
the second ML model is a ML continuous model that is generated based on a spending value specifically pertaining to the user of the client device;
the spending value represents an amount of spending by the user over a predetermined period of time;
the generating the ML model output step includes executing the second trained ML model but not the first trained ML model;
the training data includes transactional data that is specific to the user of the client device or a demographic group of users that includes the user;
the training data includes transactional data that is specific to the demographic group of users, and wherein the demographic group of users includes a plurality of users that are a part of a common income class or a common geographic class;
deposit information is passed as input into the one or more trained ML models as a part of applying the one or more trained ML models so as to generate the ML model output;
receiving user allocation data from the client device of the user, and wherein the electronic envelope distribution is based on the ML model output and the user allocation data;
applying one or more rules to the amount of the deposit after the step of generating the ML model output and before the step of allocating the amount of the deposit, wherein the one or more rules are used along with the ML model output to determine the electronic envelope distribution;
a first rule of the one or more rules includes analyzing past spending behavior of the user of the client account;
the at least one electronic envelope includes two or more electronic envelopes;
each of the electronic envelopes is associated with a bank account;
determining a financial health score of the user based on amounts of at least one of the plurality of electronic envelopes;
determining one or more financial spending patterns of the user based on amounts of at least one of the plurality of electronic envelopes;
determining one or more emotional triggers to present to the user at the client device based on transactional data of the user; and/or
determining a spending stability factor of the user, and wherein the electronic envelope distribution is modified based on the spending stability factor of the user.

According to another aspect of the invention, there is provided an electronic envelope compartmentalization system. The electronic envelope compartmentalization system includes: one or more electronic processors; and one or more memory devices each electrically connected to at least one of the one or more electronic processors and having instructions stored therein. The one or more electronic processors is configured to access the one or more electronic memories and execute the instructions stored therein such that the one or more electronic processors is configured to: generate at least one trained machine learning (ML) model by training at least one ML model with training data; receive an indication of a deposit into a bank account of a user; in response to receiving the indication of the deposit into the bank account, generate a ML model output by executing one or more of the at least one trained ML model, wherein the ML model output is used to determine an electronic envelope distribution to be applied to an amount of the deposit; allocate the amount of the deposit into the at least one electronic envelope of the plurality of electronic envelopes based on the electronic envelope distribution; and cause electronic envelope account information to be sent to a client application that is executed on a client device, wherein the client application is configured to visually display the electronic envelope account information on the client device, and wherein the electronic envelope account information indicates a balance of each of the at least one electronic envelope after having allocated the amount of the deposit.

According to various embodiments, the electronic envelope compartmentalization system may be configured to implement any one of the following features or any technically-feasible combination of some or all of the features through use of the computer instructions as executed by the one or more processors:
a first one of the at least one ML model is trained using time series data that corresponds to transactional data of a plurality of users;
the at least one ML model includes a first ML model and a second ML model, and wherein the generating step includes training the first ML model and the second ML model to obtain a first trained ML model and a second trained ML model;
the first ML model is a ML classification model that is generated based on merchant information that is associated with transactional data of the user of the client device, and wherein the ML classification model is used to generate supplemented training data used to train the second ML model;
the second ML model is a ML continuous model that is generated based on a spending value specifically pertaining to the user of the client device;
the spending value represents an amount of spending by the user over a predetermined period of time;
the generating the ML model output step includes executing the second trained ML model but not the first trained ML model;
the training data includes transactional data that is specific to the user of the client device or a demographic group of users that includes the user;
the training data includes transactional data that is specific to the demographic group of users, and wherein the demographic group of users includes a plurality of users that are a part of a common income class or a common geographic class;
deposit information is passed as input into the one or more trained ML models as a part of applying the one or more trained ML models so as to generate the ML model output;
receiving user allocation data from the client device of the user, and wherein the electronic envelope distribution is based on the ML model output and the user allocation data;
applying one or more rules to the amount of the deposit after the step of generating the ML model output and before the step of allocating the amount of the deposit, wherein the one or more rules are used along with the ML model output to determine the electronic envelope distribution;
a first rule of the one or more rules includes analyzing past spending behavior of the user of the client account;
the at least one electronic envelope includes two or more electronic envelopes;
each of the electronic envelopes is associated with a bank account;
determining a financial health score of the user based on amounts of at least one of the plurality of electronic envelopes;
determining one or more financial spending patterns of the user based on amounts of at least one of the plurality of electronic envelopes;
determining one or more emotional triggers to present to the user at the client device based on transactional data of the user; and/or
determining a spending stability factor of the user, and wherein the electronic envelope distribution is modified based on the spending stability factor of the user.

According to one aspect of the invention, there is provided a method of autonomously compartmentalizing a monetary transaction into at least one of a plurality of electronic envelopes of an account. The method includes: receiving an indication of a deposit into a bank account of a user; in response to receiving the indication of the deposit into the bank account, generating a ML model output by executing at least one trained ML model, wherein the ML model output is used to determine an electronic envelope distribution to be applied to an amount of the deposit; and allocating the amount of the deposit into the at least one electronic envelope of the plurality of electronic envelopes based on the electronic envelope distribution.

According to another aspect of the invention, there is provided an electronic envelope compartmentalization system. The electronic envelope compartmentalization system includes: one or more electronic processors; and one or more memory devices each electrically connected to at least one of the one or more electronic processors and having instructions stored therein. The one or more electronic processors is configured to access the one or more electronic memories and execute the instructions stored therein such that the one or more electronic processors is configured to: receive an indication of a deposit into a bank account of a user; in response to receiving the indication of the deposit into the bank account, generate a ML model output by executing at least one trained ML model, wherein the ML model output is used to determine an electronic envelope distribution to be applied to an amount of the deposit; and allocate the amount of the deposit into the at least one electronic envelope of the plurality of electronic envelopes based on the electronic envelope distribution

According to another aspect of the invention, there is provided one or more non-transitory, computer-readable storage mediums storing program instructions thereon that, when executed on one or more computers, causes the one or more computers to carry out the method of: generating at least one trained machine learning (ML) model by training at least one ML model with training data; receiving an indication of a deposit into a bank account of a user; in response to receiving the indication of the deposit into the bank account, generating a ML model output by executing one or more of the at least one trained ML model, wherein the ML model output is used to determine an electronic envelope distribution to be applied to an amount of the deposit; allocating the amount of the deposit into the at least one electronic envelope of the plurality of electronic envelopes based on the electronic envelope distribution; and sending electronic envelope account information to a client application that is executed on a client device, wherein the client application is configured to visually display the electronic envelope account information on the client device, and wherein the electronic envelope account information indicates a balance of each of the at least one electronic envelope after having allocated the amount of the deposit.

According to another aspect of the invention, there is provided a method of autonomously determining a financial spending score of a user based on amounts of at least one electronic envelope. The method includes: determining a spending limit of the user for a first time period, wherein the spending limit of the user is determined based on an amount of a first electronic envelope of the at least one electronic envelope; determining a spending amount of the user for the first time period based on transactional data of the user during the first time period; comparing the spending amount to the spending limit; and determining the financial health score based on a result of the comparison of the spending amount to the spending limit.

According to another aspect of the invention, there is provided a method of autonomously providing one or more emotional triggers to a user at a client device. The method includes: receiving an indication of a transaction of a bank account of a user; classifying the transaction as essential or non-essential based on transactional data of the transaction; identifying the one or more emotional triggers based on the classification of the transaction; and providing the one or more emotional triggers to the user by sending the one or more emotional triggers to the client device, wherein the client device is configured to visually display the one or more emotional triggers.

According to another aspect of the invention, there is provided a method of autonomously providing one or more emotional triggers to a user at a client device. The method includes: receiving an indication of a transaction of a bank account of a user or a transfer of amounts between one or more electronic envelopes; determining whether the transaction or the transfer negatively affects a financial health score of the user; identifying the one or more emotional triggers based on whether the transaction or the transfer negatively affects the financial health score of the user; and providing the one or more emotional triggers to the user by sending the one or more emotional triggers to the client device, wherein the client device is configured to visually display the one or more emotional triggers.

According to another aspect of the invention, there is provided a method of autonomously determining an electronic envelope distribution of a user. The method includes: generating a machine learning (ML) model output by executing at least one trained ML model; determining a spending stability factor based on transactional data of the user; and determining the electronic envelope distribution based on the ML model output and the spending stability factor.

According to another aspect of the invention, there is provided a method of autonomously allocating an amount into at least one of a plurality of electronic envelopes of an account. The method includes: receiving a user allocation request from a client device of a user, wherein the user allocation request specifies user allocation data; determining an electronic envelope distribution based at least partly on the user allocation data; and allocating the amount into the at least one electronic envelope based on the electronic envelope distribution. In one embodiment, the amount is an amount of a deposit, and the allocating step includes allocating the amount of the deposit into the at least one electronic envelope. In another embodiment, the amount is an amount of one or more other envelopes of the plurality of envelopes that is/are different than the at least one envelope, and the allocating step includes allocating the amount of the one or more other envelopes into the at least one envelope based on the electronic envelope distribution.

### BRIEF DESCRIPTION OF THE DRAWINGS

One or more aspects of the disclosure will hereinafter be described in conjunction with the appended drawings, wherein like designations denote like elements, and wherein:

FIG. 1 is a block diagram of an exemplary communications system that includes a core backend system;

FIG. 2 is a flowchart of an embodiment of a method of compartmentalizing an amount of a monetary transaction into at least one of a plurality of electronic envelopes of an account;

FIG. 3 is a flowchart of an embodiment of a method of training at least one ML model to generate at least one trained ML model that may be used as a part of the method of FIG. 2;

FIG. 4 is a flowchart of an embodiment of a method of determining an electronic envelope distribution based on a ML model output that may be used as a part of the method of FIG. 2;

FIG. 5 depicts a screen of a graphical user interface (GUI) of a client application that is used for displaying a financial spending patterns according to one embodiment; and

FIGS. 6-8 depict various screens of a GUI of the client application that are used to provide information regarding emotional trigger(s) according to one embodiment.

### DETAILED DESCRIPTION

The embodiment described below is a method and system based on autonomous, intelligent, tunable computing technology to allow users to better manage their finances. The system is autonomous in that it is driverless, requiring little, if any, user interactions to manage the finances and financial health of the user. The system is intelligent in responding to bank transactions in a fashion best optimized to the individual user. This response can occur in real-time or at specified intervals or in response to specific bank transaction or at the user request. The system is also intelligent in using a set of artificial intelligence (AI) and machine learning (ML) techniques to learn optimal allocation of incoming money/monetary transactions, in lieu of utilizing hard-coded or formula-based banking equations. The system is also intelligent in learning how to best nudge the user to increase auto saving and financial health. The system is tunable to the individual user. Once configured with initial user inputs, the system can autonomously process monetary transactions and provide notifications and recommendations to the user in a manner that is autonomously customized to that individual user. The system can also be given some directives on how to autonomously guide the user.

In general, the method and system may be used for smart, tunable, autonomous (driverless) management of a bank account by learning in real time spending patterns and the relevant allocation(s) pertaining to deposits, transfers, or other monetary transactions in which money is moved or transacted into an account. Further, the method and system may provide means for intelligent capabilities to incentivize savings, and to limit, track, and profile finances of a user as an individual and, in some instances, in reference to others in the same or other banking system.

In at least some embodiments, the system and method described herein may be used to compartmentalize a monetary transaction, such as, for example and without limitation, a bank deposit, a fund transfer, or other transaction in which money is transacted, into at least one electronic envelope. As used herein, an electronic envelope is a data structure or a portion of a data structure (e.g., a data type) that is used to electronically represent one or more values that describe an amount of resources, such as monetary funds, which may be designated for a particular purpose. These electronic envelopes may be displayed or otherwise identified to a user as a virtual representation of a monetary amount yet are maintained in the system as physically-stored data in non-transitory, computer-readable memory. In one embodiment, the electronic envelopes are used to electronically represent an amount of money that is allocated for one or more fiscal purposes or goals. For example, a first electronic envelope may be used for emergency expenses (referred to as an emergency electronic envelope), a second electronic envelope may be used for recurring expenses (referred to as a vault electronic envelope), and a third electronic envelope may be used for money that is not otherwise categorized and that may be spent (referred to as a cash electronic envelope). In an embodiment, the following system and method enable monetary resources, such as income, to be compartmentalized into a plurality of electronic envelopes of one or more accounts.

In an embodiment, the system and method described herein are at least substantially autonomous in the sense that some or all of the functionality of the system and the steps of the method are performed autonomously and without any user input or involvement. Further, in at least some embodiments, the functionality of the system and the steps of the method are performed in an individualized manner for a particular user.

According to one embodiment, the method includes using at least one trained machine learning (ML) model to generate a ML model output that is then used to indicate how incoming monetary resources, such as a paycheck, are to be allocated among the plurality of electronic envelopes. This method may include generating the at least one trained ML model by training at least one ML model with training data. The method may further include receiving an indication of a deposit, transfer, or other transaction in which money is being moved or transacted into a bank account of a user (collectively, “a deposit”); in response thereto, generating a ML model output by executing the at least one trained ML model; and allocating the amount of the deposit into at least one electronic envelope of the plurality of electronic envelopes based at least in part on the ML model output. The method may further include sending electronic envelope account information to a client application that is executed on a client device, so that the client device visually displays the electronic envelope account information to the user. This electronic envelope account information may be used to indicate a balance of each of the at least one electronic envelope after having allocated the amount of the deposit. It will be appreciated that depending on the embodiment, the method may include all of the steps identified above or may alternatively include some but not all of the identified steps. For example, in an embodiment, the method may include only the steps of receiving an indication of a deposit, generating a ML model output by executing at least one trained ML model, and allocating the amount of deposits into at least one electronic envelope based on the ML model output. Accordingly, it will be appreciated that different embodiments of the method may include different steps, and that the method is not intended to be limited to any particular steps.

Additionally, in an embodiment, the method is entirely or largely an autonomous process in the sense that some or all of the steps are performed without input or involvement on the part of a user or others. For example, in an embodiment, at least the steps of executing at least one trained ML model and allocating the amount of deposits into at least one electronic envelope based on the ML model output are autonomously performed in response to the receipt of an indication of a deposit.

In any event, at least in one embodiment, the generation of the at least one trained ML model is performed prior to the step of receiving the indication of a deposit into a bank account of a user whereas the execution of the at least one trained ML model is carried out in response to receiving the indication of the deposit into the bank account of the user. At least in one embodiment, the execution of the at least one trained ML model may be carried out by a one or more electronic processors, a computer, or a computer system (e.g., a real-time computer system) that is configured to generate the ML model output using the trained ML model(s) so as to be able to swiftly determine an electronic envelope distribution. As used herein, a real-time computer system is a computer system that is configured to wait for receipt of data inputs and then to generate a response for each data input with the expected or average response time being less than a predetermine threshold value. As those skilled in the art will appreciate, the predetermined threshold value is different for different computing environments and different applications, but will nonetheless be appreciated by those skilled in the art. In one embodiment, for example, the expected or average response time is one (1) minute; in another example, the expected or average response time is 1 hour; and, in yet another embodiment, the expected or average response time is 1 day.

At least according to some embodiments, the above-described technical features enable the at least one ML model to be trained ahead of time (i.e., prior to receiving the indication of a deposit into a bank account of a user) while also enabling the execution of the trained ML model(s) to be carried out in real-time—accordingly, this achieves both the technical advantage of allowing a sufficient amount of time for extensively training the ML model(s) that may be uniquely tailored to a particular user or group of users while also enabling an electronic envelope distribution to be determined in real-time for each of the users in response to changes of the particular user's resources, such as in response to receiving a paycheck into a bank account of the user.

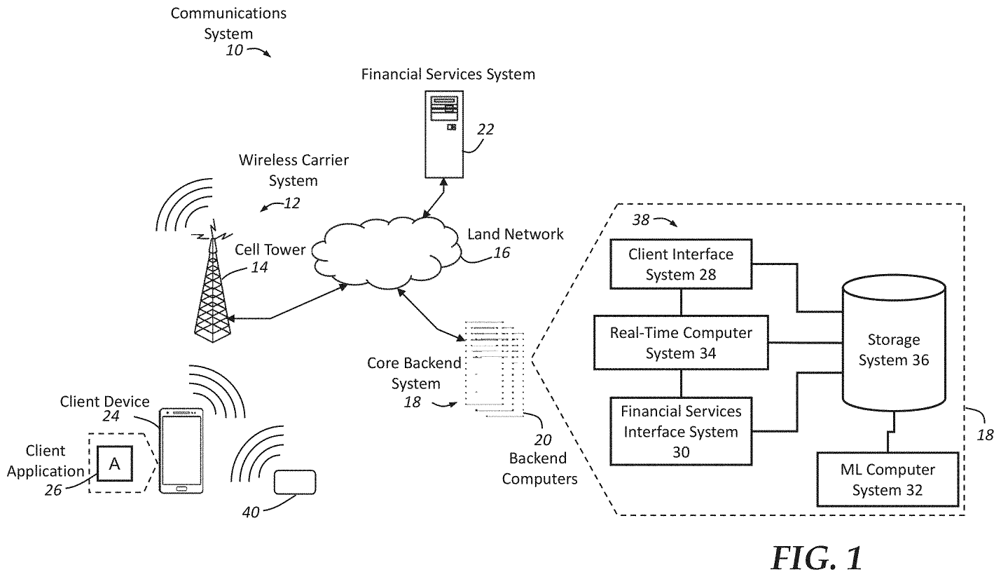

FIG. 1 depicts a communications system 10 according to one embodiment. The communications system 10 includes a wireless carrier system 12 having a cell tower 14, a land communications network 16, a core backend system 18 having one or more backend servers 20, a financial services system 22, and a client device 24 having a client application 26. It should be appreciated that, in other embodiments, the communications system 10 may use a different arrangement and/or configuration of these systems and components, or that different systems and/or components may be used.

The wireless carrier system 12 may be any suitable cellular data or telephone system. The wireless carrier system 12 is depicted in FIG. 1 as including a single cellular tower 14; however, the wireless carrier system 12 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components required to connect wireless carrier system 12 with the land communications network 16 or to connect the wireless carrier system with user equipment (UE), which, in the present embodiment, includes the client device 24. The wireless carrier system 12 may implement any suitable communications technology, including for example GSM/GPRS technology, CDMA or CDMA2000 technology, LTE technology, etc. In general, the wireless carrier system 12, its components, the arrangement of tis components, the interaction between the components, etc. is generally known in the art.

The land communications network 16 (or “land network” for short) may be a conventional data communications network that provides connectivity to between remote devices, and that can be used to connect the wireless carrier system 12 to one or more networks or devices that are remote to one another, such as the core backend system 18, the financial services system 22, and the client device 24. In one embodiment, the land network 16 includes a packet-switched data communications network that is used to provide access to Internet infrastructure. One or more segments of the land network 16 may be implemented through the use of a standard wired network, a fiber or other optical network, a cable network, power lines, other wireless networks such as wireless local area networks (WLANs), or networks providing broadband wireless access (BWA), or any combination thereof.

In an embodiment, the core backend system 18 is used to carry out an autonomous monetary transaction compartmentalization process, which is described below. The core backend system 18 is a “backend” system in the sense that it provides and enables functionality that is used by a front-end device, i.e., a client device, such as the client device 24. The core backend system 18 may be a part of a remote facility and is considered “remote” in the sense that it is not provided at the location where the client device 24 is used. The core backend system 18 may be located at a single remote facility or may be distributed among a plurality of remote facilities. For example, the core backend system 18 may carry out a first set of steps of the monetary transaction compartmentalization process at a first remote facility and a second set of steps of the monetary transaction compartmentalization process at a second remote facility that is separate from the first remote facility. As another example, the core backend system 18 may carry out various functionality at two remote facilities, each serving client devices that are geographically nearest to those facilities. Further, it will be appreciated that in at least some embodiments, the core backend system 18 and/or the constituent components or systems thereof described below, is/are entirely or largely autonomous systems in the sense that some or all of the functionality thereof (e.g., the monetary transaction compartmentalization process) is performed autonomously and without input or involvement on the part of a user or others.

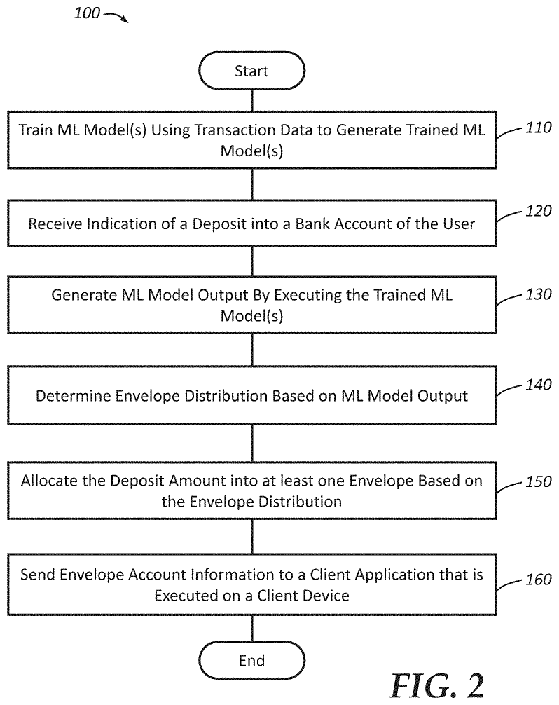

According to at least one embodiment, the core backend system 18 comprises an electronic envelope compartmentalization system 38. The electronic envelope compartmentalization system 38 includes one or more electronic processors, such as those of the one or more backend computer(s) 20, that are used to execute computer instructions, which may be stored on one or more electronic memories accessible by the one or more processors, and that may be part of or separate from the system 38. When the computer instructions are executed, the processors cause the electronic envelope compartmentalization system 38 to carry out one or more steps of the method 100 (FIG. 2) and, in one embodiment, cause the electronic envelope compartmentalization system 38 to carry out the method 100.

The core backend system 18 includes one or more backend computers 20 and, in at least some embodiments, includes a plurality of backend computers 20. The backend computer(s) 20 are each an electronic computer that includes an electronic processor that is configured to execute computer instructions that are stored on a non-transitory, computer-readable memory accessible by the processor. One or more of the backend computer(s) 20 may be configured as, for example, a server that provides data to the client application 26 of the client device 24, a server that interfaces with the financial services system 22, a computer that is used to configure a ML model, a real-time computer that carries out one or more steps of the monetary transaction compartmentalization process, a computer that interfaces/accesses one or more databases (e.g., one or more databases of the storage system 36), etc.

In the illustrated embodiment, the core backend system 18 includes a client interface system 28, a financial services client interface system 30, a ML computer system 32, and a real-time computer 34, although it should be appreciated that the core backend system 18 may include one or more other computers or systems. The client interface system 28 is used to provide data to and receive data from the client application 26 of the client device 24. The financial services interface system 30 is used to provide data to and receive data from the financial services system 22. The ML computer system 32 is used to train at least one ML model so as to generate at least one trained ML model. The trained ML model(s) may be executed by the ML computer system 32 and/or the real-time computer system 34.

The core backend system 18 may include systems or components other than those systems 28-32. According to some embodiments, each of the systems 28-32 is implemented using computers that are separate from those used to implement other systems; for example, in one embodiment, the one or more computers that are used to implement the client interface system 28 are separate from the one or more computers that are used to implement the financial services interface system 30 and the ML computer system 32. However, in other embodiments, one or more of the systems 28-34 (and/or other components or systems that may form a part of the core backend system 18) may be implemented using the same (or at least one of the same) computers; for example, in one embodiment, the one or more computers that are used to implement at least part of the client interface system 28 are also used to implement at least part of the financial services interface system 30 and/or the ML computer system 32. It should be appreciated that the core backend system 18 is not necessarily limited to any particular number, arrangement, and/or configuration of computers, components, devices, etc.

The client interface system 28 is used to provide data to and receive data from the client application 26 of the client device 24. In at least some embodiments, the communications system 10 includes more than one client device 24 and, in such embodiments, the client interface system 28 is used to provide data to and receive data from a client application 26 of each of the client devices 24. The client interface system 28 is coupled to the storage system 36 such that the client interface system 28 is able to access data from memory of the storage system 36. The client interface system 28 may also provide data to the storage system 36, which may then store the data therein. According to at least one embodiment, the client interface system 28 includes one or more client interface servers, each of which is implemented by at least one of the backend computer(s) 20.

In one embodiment, the client interface system 28 receives a request from the client device 24 and, in response to the request, generates a response. In at least some scenarios, the response is based on or includes data from the ML computer system 32 and/or the real-time computer system 34. The client interface system 28 may receive data from the ML computer system 32 and/or the real-time computer system 34 directly or indirectly via storage system 36. The client interface system 28 may be implemented as an application programming interface (API) that defines the structure, format, and resource/network paths (e.g., URIs or URLs) to be followed for requesting data from the client interface system 28, requesting or directing operations of the client interface system 28 and/or other part of the core backend system 18, and for providing data to the client interface system 28. The API of the client interface system 28, which is referred to herein as the client API, may provide a consistently structured and reliable mechanism for the client application 26 to use when communicating with the client interface system 28.

The financial services interface system 30 is used to provide data to and receive data from the financial services system 22. In at least some embodiments, the communications system 10 includes more than one financial services system 22 and, in such embodiments, the financial services interface system 30 is used to provide data to and receive data from each of the financial services systems 22. The financial services interface system 30 is coupled to the storage system 36 such that the financial services interface system 30 is able to access data from the storage system 36, such as from a database of the storage system 36. The financial services interface system 30 may also provide data to the storage system 36, which may then store the data therein. According to at least one embodiment, the financial services interface system 30 includes one or more financial services interface servers, each of which is implemented by at least one of the backend computer(s) 20.

In one embodiment, the financial services interface system 30 may be implemented as an API that defines the structure, format, and resource/network paths (e.g., URIs or URLs) to be followed for requesting data from the financial services interface system 30; requesting or directing operations of the financial services interface system 30 and/or other part of the core backend system 18; and/or for providing data to the financial services interface system 30. The API of the financial services interface system 30, which is referred to herein as the financial services API, may provide a consistently structured and reliable mechanism for the financial services system 22 or other network computer device to use when communicating with the financial services interface system 30.

The ML computer system 32 is used to train at least one ML model so as to generate at least one trained ML model. The trained ML model(s) are used to generate a ML output based on a ML input and, according to one embodiment, may be executed by the real-time computer system 34, the ML computer system 32, and/or a combination thereof. The ML computer system 32 may be implemented on any number of computers and according to any number of configurations. For example, a first ML model of the ML computer system 32 may be trained on a first computer and a second ML model of the ML computer system 32 may be trained on a second computer that is different from the first computer. As another example, a first ML model of the ML computer system 32 may be trained partly on a first computer and partly on a second computer. Additionally, the computer(s) that are used to implement the ML computer system 32 may be shared and used for other purposes, such as for the client interface system 28. However, in at least one embodiment, the ML computer system 32 is implemented at least partly on a computer that is dedicated for training at least one ML model so as to generate a trained ML model.

The trained ML model(s) may implement any of a number of various ML techniques or models, which are each referred to herein as a ML model. Such ML models may include, for example, support vector machine techniques and artificial neural networks. In one embodiment, a deep neural network or a deep learning neural network having two or more hidden layers, an input layer, and an output layer may be used. In one embodiment, the ML computer system 32 is used to implement a ML training process that is used to train at least one ML model so as to generate at least one trained ML model. The trained ML models may then be executed, such as by the ML computer system 32 and/or the real-time computer system 34, so as to generate a ML model output that is used, at least in part, to determine an electronic envelope distribution to be applied to a monetary transaction (e.g., to the amount of a deposit). In embodiments where the ML model output is generated by a system other than the real-time computer system 34 (e.g., the ML computer system 32), the ML model output may be provided to the real-time system 34. Additionally, or alternatively, the ML model output may be stored in the storage system 36, and this ML model output may later be recalled by other system of the core backend system 18, such as the client interface system 28, the ML computer system 32, and/or the real-time computer system 34. The real-time computer system 34 may be implemented on any number of computers and according to any number of configurations.

The real-time computer system 34 is a computer system that operates to provide real-time processing in response to changes in account information of the user's bank account(s). The real-time processing may be used to carry out portions of the monetary transaction compartmentalization process, such as an allocation process, in response to receiving an indication of a deposit into a bank account of the user. In one embodiment, the real-time computer system 34 executes one or more of the trained ML model(s) that were generated by the ML computer system 32 and that may be stored in the storage system 36. Alternatively, or additionally, the real-time computer system 34 may perform additional operations, including those that are not necessarily carried out in response to changes in the account information of the user's bank account(s).

The storage system 36 is used to store data that is used by the core backend system 18. The storage system 36 may include one or more non-volatile memory devices, such as hard disk drives (HDDs), magnetic or optical disc drives, ROM (read-only memory), solid-state drives (SSDs) (including other solid-state storage such as solid-state hybrid drives (SSHDs)), etc. Although the storage system 36 is shown as being separate from the other systems and components of the core backend system 18, it should be appreciated that the storage system 36 may be integrated as a part of any one or more of those systems. For example, a first part of the storage system 36 may be integrated with the real-time computer system 34 with both of these systems 34, 36 being implemented on the same computer(s), and a second part of the storage system 36 may be integrated with the ML computer system 32 with both of these systems 32, 36 being implemented on the same computer(s).

In one embodiment, the storage system 36 may include one or more databases that are each used to store a collection of data that is used by the core backend system 18. The database(s) may each be managed by a database management system (DBMS), such as MySQL™, PostgreSQL™, MSSQL™, etc. The DBMS is used by the core backend system 18 to commit/store data to the database(s), to modify data in the database(s), to manage the database schema of the database(s), and to retrieve data from the database(s). The DBMS may be used to serve data from the database(s) to various other parts of the core backend system 18, such as the client interface system 28, the financial services interface system 30, the ML computer system 32, and the real-time computer system 34.

Any one or more of the processors (or electronic processors) discussed herein may be any of a variety of devices capable of processing electronic instructions, including microprocessors, microcontrollers, host processors, vehicle communication processors, and application specific integrated circuits (ASICs). Any one or more of the processors may be a dedicated processor used only for the monetary transaction compartmentalization process or related processes, or may be shared with other systems. Any one or more of the processors may execute various types of digitally-stored instructions, such as software or firmware.

Any one or more of the memories discussed herein may be any of a variety of electronic memory devices that can store computer instructions and/or other electronic information, such as a powered temporary memory, or any suitable non-transitory, computer-readable medium. Such examples can include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, or other component suitable for storing computer instructions used to carry out the various operations or functions discussed herein.

Each of the connections between the various components of the core backend system 18 may be a hardwired connection or a wireless connection. The types of these various connections may be different or the same as one another. Some exemplary hardwired connections that may be used are a controller area network (CAN) connection, a fiber connection, a coaxial cable connection, and an ethernet cable connection including an IEEE 802.3 connection. Some exemplary hardwired connections that may be used are a Wi-Fi™ connection (e.g., a Wi-Fi™ direct connection), other IEEE 802.11 connection, a Bluetooth™ connection (e.g., Bluetooth™ Low Energy (BLE) connection), other IEEE 802.15 connection, a ZigBee™ connection, a Zwave™ connection, a MiWi™ connection, and a cellular or other radio-based connection.

The financial services system 22 is a computer system that is used to provide any of a variety of financial services, such as online computerized banking. In one embodiment, the financial services system 22 is an electronic banking system that is provided by a bank that holds monies of a user of the client device 24. In some embodiments, the system 10 includes one or more additional financial services systems 22 that are connected to the land communications network 16 and that operate in a similar manner as the financial services system 22 described above. In one embodiment, the financial services system 22 may provide credit services, such as issuing credit cards, in addition to traditional banking services. The financial services system 22 may store or provide access to various information relating to one or more bank accounts of the user. This information may include, for example, an account balance of one or more bank accounts of the user and transactional data of the one or more bank accounts. As used herein, transactional data refers to information that is a part of a transaction that has been carried out for one or more bank accounts, and may include a merchant name or identifier, an amount of the transaction, an indicator of whether the transaction was incoming (e.g., a deposit) or outgoing (e.g., a withdrawal), and a bank account identifier of which the transaction is a part. In one embodiment, the financial services system 22 is managed, controlled, owned, and/or operated by a financial institution, such as a bank, that holds the funds of the user. In other embodiments, the financial services system 22 is not managed, controlled, owned, and/or operated by a financial institution, but still provides information regarding account information of one or more bank accounts held by the user at one or more financial institutions.

In the illustrated embodiment, the client device 24 is a handheld mobile device, which may be a handheld computer that includes wireless communication capabilities. The client device 24 is illustrated as a smartphone; however, other mobile computers or computing devices, such as, for example, tablets and laptops, may be used as the client device 24 and/or stationary computers, such as, for example, a personal desktop computer, may be used as the client device 24. The client device 24 may include a cellular chipset for carrying out wireless communications, such as cellular communications. The client device 24 may use the cellular chipset for communicating with other components of the communications system 10, such as the client interface system 28 of the core backend system 18. The client device 24 may also include short-range wireless communication (SRWC) circuitry enabling SRWC technologies to be used to send and receive data. The client device 24 may use the SRWC circuitry to communicate with a wireless access point that is connected to the wireless carrier system 12 and/or the land communications network 16, such as via a network access device (NAD) (e.g., a modem).

In one embodiment, the system 10 may further include a digital display card 40 that is used to present electronic envelope account information, such as a balance of at least one of the electronic envelopes, such as the cash electronic envelope. In other embodiment, the digital display card 40 is used to present other information to the user. At least in one embodiment, the digital display card 40 is approximately the size of a credit card. The digital display card 40 includes an electronic display that is used to display information, such as a numerical value representing a balance of at least one of the electronic envelopes, such as the cash electronic envelope. The digital display card 40 may include wireless circuitry so that it may receive data from the client device 24, such as via Bluetooth™ or RFID technology.

With reference to FIG. 2, there is shown a method 100 of compartmentalizing a monetary transaction into at least one of a plurality of electronic envelopes of an account. In one embodiment, the method 100 is used to compartmentalize incoming monetary funds, such as a paycheck or other incoming funds or money, into a plurality of electronic envelopes of a user's bank account. The embodiment of the method 100 is described as being carried out by the core backend system 18, although, in other embodiments, one or more steps of the method 100 may be carried out by one or more other components or systems, including, but not limited to, one or more of those other components or systems described above. The method 100 includes a monetary transaction compartmentalization process, which, in an embodiment, includes both a ML training process (step 110) and an autonomous allocation process (step 130). The ML training process is used to train at least one ML model so as to generate at least one trained ML model that is used in the autonomous allocation process. The allocation process is a process that is executed in response to receiving an indication of a change to a user's bank account (e.g., a deposit being received) and that uses the at least one trained ML model to generate a ML model output that is used to determine an electronic envelope distribution to be applied to an amount of the deposit. At least in one embodiment, the allocation process is a process that is performed in real-time in response to an indication of a deposit so as to determine an allocation of an amount of the deposit in a responsive and timely fashion.

In an embodiment, the method 100 begins with step 110, wherein at least one trained ML model is generated by training at least one ML model with training data. Any one or more of the at least one ML model may be selected from a variety of ML models, such as a recurrent neural networks (RNNs), boosting and bagging, support vector machines, random forest classifiers, logistic regression models, OLS-regression models, random forest regressors, neural network-based models, Facebook™ Prophet models, and stochastic gradient descent regressors, other ML models, or any suitable combinations thereof.

The training data may include transactional data of various bank accounts of various users, such as financial data. In at least one embodiment, as a part of initial training, the transactional data is not specific to the user of the client device 24, but is for a larger group of users. The initial training, which uses non-user-specific training data, results in generating at least one initial trained ML model. Each of the at least one initial trained ML models may be further refined for a particular user or a particular group of users, as discussed below.

Each initial trained ML model may be further trained, such as at a later time, using training data that includes transactional data that is specific to a user and/or specific to a demographic group of users that includes the user. As used herein, a demographic group of users is a group that includes a plurality of users that share a common demographic, such as where the users are geographically located in the same area (referred to herein as a “common geographic class”), the users are classified in the same income class (referred to herein as a “common income class”), the users are in the same age group, etc. Additionally, or alternatively, each initial trained ML model may be trained using transactional data that is specific to the user of the client device 24. In one embodiment, the further training can be autonomous, triggered based on changes in spending or a significant amount of new user transactions. In another embodiment, the further training can be repeated at specific time periods. In yet another embodiment, the further training can be triggered by the output of a machine learning model, such as recurrent neural networks, that learns that changes in the user spending transactions warrants retraining the model.

In one embodiment, the at least one ML model includes a ML classification model and a ML continuous model. As used herein, a ML classification model is any ML model that is used to determine or output a classification, label, or other discrete value. As used herein, a ML continuous model is any ML model that is used to determine or output a continuous value. In such an embodiment, the ML classification model may be trained to generate a trained ML classification model and the ML continuous model may be trained to generate a trained ML continuous model. In one embodiment, the ML classification model may be trained using merchant information that is associated with transactional data of the user. The transactional data may include a merchant name or identifier (collectively, “merchant identifier”), and this merchant identifier may be used to determine merchant information, such as a merchant type or category (e.g., grocery, utilities, entertainment). In one embodiment, the ML continuous model is a ML regression model or a ML recurrent neural network (RNN) model. The ML continuous model may be trained using spending information that is obtained based on transactional data of the user. The spending information may include an amount that a user spends for a given time period, such as in the last 30 days or for some other predetermined time period.

In one embodiment, the at least one trained ML model is a trained ML continuous model (e.g., a trained ML regression model) that is trained using supplemented training data. The supplemented training data is training data that initially, when obtained by the core backend system 18, was missing certain information, such as merchant information, but that was modified to fill in the missing information (or at least a part thereof). In at least one embodiment, the training data may be supplemented to obtain the supplemented training data through use of a supplemental ML model, which may be a ML classification model. That is, this supplemental ML model may be used to supplement the training data so as to fill in the missing information. Of course, in other embodiments, other types of ML models or techniques may be used to generate this supplemented training data. The supplemented training data may then be used for training another ML model, which may be a ML regression model or other ML continuous model. As discussed more below, step 130 may execute the trained ML model that was trained using the supplemented training data, but, at least in one embodiment, does not execute the supplemental ML model. In such an embodiment, the supplemental ML model is executed during the training process as a part of training the ML model that is then executed during step 130.

In at least one embodiment, the at least one trained ML model(s) are saved to memory, such as that of the storage system 36. Each of the trained ML model(s) may be serialized so as to be represented in a format that is more readily storable in memory. For example, in one embodiment, each of the trained ML model(s) are serialized using a pickle operation. The method 100 continues to step 120.

In step 120, an indication of a deposit into a bank account is received. While the description of method 100 has thus far been with respect to an embodiment wherein the method 100 includes the training step 110, in other embodiments, the method 100 does not include the training step 110 (the training step is not performed as part of method 100 but instead is performed before the method 100 is carried out and a trained ML model is saved to memory for use by the method 100) but rather method 100 begins at step 120 rather than step 110. In any event, in one embodiment, this indication is received at the financial services interface 30 of the core backend system 18. The financial services system 22 may send a message that includes the indication via land network 16 to the financial services interface 30. After having received the indication, the financial services interface 30 may forward the indication to the real-time computer system 34 and/or save the indication in the storage system 36. The indication of the deposit may be accompanied by an amount of the deposit. For example, if a deposit of $1,000 was made into a bank account of the user, a message indicating this value ($1,000) may be sent from the financial services system 22 to the financial services interface 30, which may forward this deposit amount indication to the real-time computer system 34 and/or save the deposit amount indication in the storage system 36.

In one embodiment, an indication of the deposit may be retrieved from a first financial services system 22, which may be associated with a first financial institution, and transactional data may be obtained from a second financial services system 22, which may be associated with a second financial institution and that is separate from the first financial services system 22. For example, the first financial services system 22 may support electronic banking for an income bank account of the user whereas the second financial services system 22 may support electronic credit card management and that includes transactional data relating to transactions effected using a credit card or account of the user. The method 100 continues to step 130.

In step 130, a ML model output is generated by executing one or more of the trained ML model(s). In at least one embodiment, the ML model output is generated in response to receiving the indication of the deposit into the bank account. In one embodiment, the ML model output includes one or more prediction values that are used to indicate a portion of the amount of the deposit to be allocated to each of the electronic envelopes. In one embodiment, the one or more prediction values are obtained as a result of executing the trained ML regression model, which may be trained using supplemented training data as discussed above. In other embodiments, the one or more prediction values are obtained as a result of executing another trained ML continuous model.

In one embodiment, this step includes retrieving the one or more trained ML models from memory and then executing the retrieved trained ML model(s) to generate a ML model output. For example, the ML computer system 32 may store the trained ML regression model into storage system 36. Then, in this example, in response to receiving the indication of the deposit into the bank account, the trained ML regression model is retrieved from the storage system 36 and then executed by the real-time computer system 34 to generate the ML model output. In at least some embodiments, the amount of the deposit is used as input into one or more of the trained ML model(s) and, accordingly, the ML model output is based on the amount of the deposit. In another embodiment, the ML model output does not use the amount of the deposit as input—in such an embodiment, a percentage amount for each electronic envelope is determined based on the ML model output and then applied to the amount of the deposit to provide an amount of funds or money to be allocated to each electronic envelope. As discussed more below, in one embodiment, the ML model output may be the electronic envelope distribution. The method 100 continues to step 140.

In step 140, an electronic envelope distribution is determined based on the ML model output. The ML model output is used to determine an electronic envelope distribution to be applied to an amount of the deposit. The electronic envelope distribution indicates a portion of the amount of the deposit that is to be allocated to one or more electronic envelopes, and will be discussed in more detail below. In one embodiment, the electronic envelope distribution is provided by the ML model output—that is, the electronic envelope distribution is derived solely from the ML model output and not based on other information. For example, the ML model output may generate one or more numerical values that indicate a percentage of the amount of the deposit that is to be allocated to each of the electronic envelopes. In one embodiment, the ML model output may indicate that 30% of the amount of the deposit is to be allocated to a first electronic envelope (e.g., a “Cash” electronic envelope), 20% of the amount of the deposit is to be allocated to a second electronic envelope (e.g., the vault electronic envelope), and 10% of the amount of the deposit is to be allocated to a third electronic envelope (e.g., the emergency electronic envelope). However, in other embodiments, the ML model output is obtained based on other data or information too and, in one of such embodiments, the ML model output is modified using one or more rules to obtain modified ML model output that is then used as the electronic envelope distribution. The method 300 discussed below provides an example in which the electronic envelope distribution is generated based on modifying the ML model output. The electronic envelope distribution may be stored in the storage system 36. In an embodiment, some or all of the functionality described above with respect to step 140 may be performed autonomously and without any input or involvement on the part of the user. The method 100 continues to step 150.

In step 150, the amount of the deposit is allocated into at least one electronic envelope of the plurality of electronic envelopes based on the electronic envelope distribution. As mentioned above, the electronic envelope distribution is determined based on the ML model output. In one embodiment, the real-time computer system 34 inspects the ML model output and determines the electronic envelope distribution. In one embodiment, the real-time computer system 34 may then cause the amount of the deposit to be allocated into at least one electronic envelope of a plurality of electronic envelopes that are a part of the user's client account. In an embodiment, the user's client account is separate from the user's bank account and is an account of the user that is held as a part of the client application 26. As discussed below, in at least some embodiments, although the electronic envelopes are held as a part of the user's client account, the electronic envelopes may each be associated with a bank account of the user.

As mentioned above, the user may hold one or more bank accounts with one or more financial institutions. However, the core backend system 18 may be used to provide the user with various services that relate to assisting the user with financial management, even though the core backend system 18 may be separate and, in some embodiments, not permitted control over those bank accounts. In this sense, the core backend system 18 provides access to information associated with those bank accounts and provides related financial information to the user, such as in the form of various electronic envelopes that are marked or labeled for different purposes. By organizing the user's finances into such electronic envelopes, the core backend system 18 is able to present the user with useful information so that the user may make informed decisions regarding spending and management of their funds held in their bank accounts.

In one embodiment, each of the electronic envelopes is associated with a single bank account, such as a checking or savings account. Thus, in such an embodiment, each electronic envelope corresponds to a single, respective bank account of the user such that there is a one-to-one relationship between the electronic envelopes and the bank accounts. In other embodiments, a single electronic envelope is associated with multiple bank accounts such that there is a one-to-many relationship between the electronic envelopes and the bank accounts. And, in another embodiment, a plurality of electronic envelopes is associated with a single bank account such that there is a many-to-one relationship between the electronic envelopes and the bank accounts.

In one embodiment, this step 150 includes determining an amount of funds to allocate to each of the electronic envelopes, but does not include actually effecting bank transfers of funds—instead, values associated with each electronic envelope are modified or allocated according to the electronic envelope distribution. However, in other embodiments, this step includes causing or effecting at least one bank transfer of funds from a first bank account to a second bank account. For example, the financial services interface 30 sends a message to the financial services system 22 that effects a first transfer of funds in which funds are transferred from a first bank account of the user to a second bank account of the user according to the electronic envelope distribution. The financial services interface 30 may cause one or more other transfers to be effected, which may include a second transfer of funds to be effected in which funds are transferred from the first bank account of the user to a third bank account of the user according to the electronic envelope distribution. In one embodiment, the first bank account is a hidden bank account, which is bank account that is not associated with an electronic envelope. In at least one embodiment, information concerning the hidden bank account is not displayed to the user using the client application 26. In some embodiments, the hidden bank account is an income bank account, which is a bank account that is used by the user to receive income, such as paychecks. In one embodiment, with reference to step 120, the bank account that is associated with the indication of the deposit (step 120) is a hidden bank account and/or an income bank account. In an embodiment, some or all of the functionality described above with respect to step 150 may be performed autonomously and without any input or involvement on the part of the user. The method 100 continues to step 160.

In step 160, electronic envelope account information is sent to a client application that is executed on a client device. The electronic envelope account information indicates a balance of each of the at least one electronic envelope. This step is carried out after step 150 and, accordingly, the electronic envelope account information indicates the balance of each of the at least one electronic envelope after having allocated the amount of the deposit. The electronic envelope account information may include other information, such as, for example, electronic envelope distribution information that indicates the amount of the deposit and portions of the amount of the deposit along with the corresponding electronic envelope that each of the portions was allocated to so that the user may be apprised of how the amount of the deposit was allocated among the electronic envelopes.

In an embodiment, the client application 26 is used to present the electronic envelope account information to the user. In at least one embodiment, the client application 26 is configured such that, when the client application 26 is executed by the client device 24, the client device 24 visually presents the electronic envelope account information to the user, which may include presenting the electronic envelope account information on a visual display of the client device 24 or otherwise providing a visual indication of the electronic envelope account information to the user using the client device 24. In one particular embodiment where the client device 24 is a smartphone, the visual display is a touchscreen display of the smartphone that is used to graphically display the electronic envelope account information. In an embodiment, some or all of the functionality described above with respect to step 160 may be performed autonomously and without any input or involvement on the part of the user. The method 100 then ends.

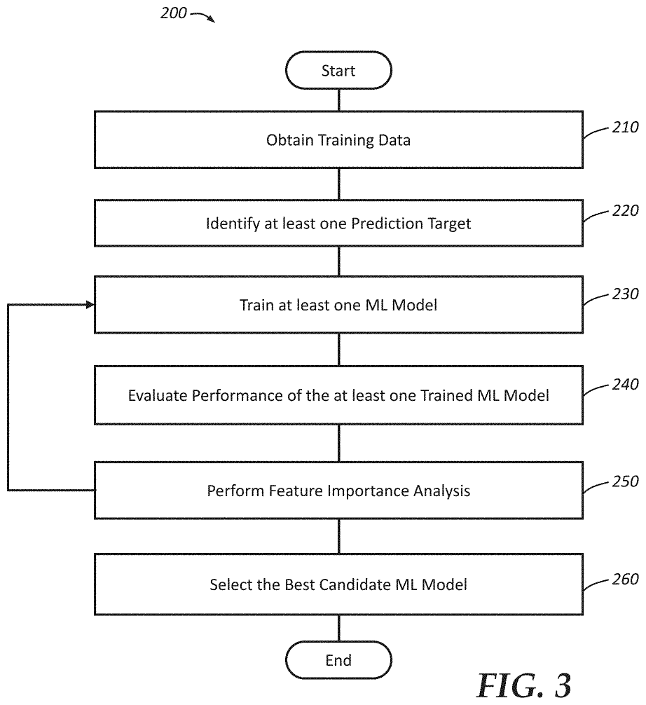

With reference to FIG. 3, there is shown a method 200 for training at least one ML model to generate at least one trained ML model. The embodiment of the method 200 is described as being carried out by the core backend system 18, although, in other embodiments, one or more steps of the method 200 may be carried out by one or more other components or systems, including, but not limited to, one or more of those other components or systems described above. In at least one embodiment, the method 200 is used to create one or more predictive ML models that are used to predict one or more transactions of one or more bank accounts of a user, which may then form the basis (or at least part of the basis) for determining the electronic envelope distribution as used in the method 100.

The method 200 begins with step 210, in which training data is obtained for use in training and evaluating the at least one ML model. As discussed above, the training data may be transactions of bank accounts of different individuals (e.g., millions of transactions for thousands of bank accounts obtained from Yodlee™), transactions associated with one or more demographic groups of users, transactions from the user of the client devices 24, or any combination thereof. In one embodiment, the training data, which may be obtained from the various sources, is shuffled or otherwise processed to increase the speed of the training, reduce variance, and/or reduce overfitting.

In at least one embodiment, this step further includes carrying out one or more preprocessing tasks on the training data. For example, a first preprocessing task pertains to extending the training data by supplementing that data with auxiliary data consisting of lagging calculations of transaction amounts. In one embodiment, the auxiliary data represents or otherwise includes the average and/or standard deviation of a particular transaction type for the past predetermined period of time, for example, a predetermined number of days. For example, the auxiliary data represents the average and/or standard deviation of a particular transaction type for the past three (3) days, seven (7) days, and 30 days. Additionally, or alternatively, the auxiliary data may include other aggregated data representing the median, maximum, minimum, and/or other accounting operations. The duration and time window used for the aggregation may include a fixed time window (e.g., Monday through Friday) or one or more different specified time intervals.

In at least one embodiment, the transactional data, which may include data representing individual transactions and/or aggregated transactions, is split into training data and evaluation data, which may include one or more evaluation datasets. The training data may be used to train any one or more of the trained ML model(s) and the evaluation data is used to evaluate how well any one or more of the trained ML model(s) performs. In another embodiment, two or more evaluation sets may be used, wherein at least a first evaluation set is used to evaluate how well any one or more of the trained ML model(s) performs and at least a second evaluation set is used for selecting the best model of a set of trained candidate ML models, which is discussed more below. The method 200 continues to step 220.

In step 220, at least one prediction target is identified. In one embodiment, the prediction target is the average spending of the past 30 days for a particular user; however, of course, another predetermined amount of time may be used instead of 30 days. In other embodiments, multiple targets are selected. At least in one embodiment, for example, the targets selected are the average spending of the past 30 days and the merchant name.

Once the target(s) is/are selected, one or more ML model architecture(s) is/are selected. For predicting numerical values (e.g., the average spending of the past 30 days), a ML regression model architecture is utilized. In one embodiment, linear regression is utilized, where the predicted value is a linear combination of the model parameters. In another embodiment, recurrent neural networks (RNNs) are utilized, which allow for capturing the time-series aspect of user-specific transactional data. Each user transaction history consists of a sequence of transactions of the user's bank account, and is organized chronologically. Each transaction may be represented by a vector of multiple features, including the amount of the transaction, the name of the merchant, the merchant's city or other geographical location, the transaction date, and/or other relevant information. The RNN model, which is an example of a ML continuous model, takes as input the transactions, which are chronologically-ordered sequences, and, as output, the RNN model computes the average spending of the past 30 days while considering various 30-day transaction windows to improve the prediction. Of course, other time windows other than 30 days may be used. In other embodiments, other types of RNN variations may be utilized, such as bidirectional RNN and Deep RNNs. In another embodiment, long short-term memory neural network architecture may be utilized.

In step 220, according to at least one embodiment, if the target is a string (e.g., the merchant's name, the merchant's category, the merchant's city), classification may be performed using a ML classification model. In some embodiments, certain information may not be included in the transactional data or the initial training data. Examples of missing information may include, but is not limited to, the merchant name or merchant category. The training data may be supplemented to fill in this missing information (or at least a part thereof) using a supplemental ML model, as discussed above in the method 100. Various techniques may be used to determine or otherwise obtain the supplemented training data, which, at least in some embodiments, is used to enhance prediction accuracy of the trained ML model. In one embodiment, Random Forest (RF) classification is utilized. An RF classifier is a meta estimator that fits a number of decision tree classifiers on sub-samples of the training data. The RF classifiers are used for averaging across decision tree classifiers to improve the predictive accuracy and control over-fitting. In another embodiment, boosting and bagging is utilized to predict the merchant name. Boosting uses decisions trees with few splits. In boosting, decision trees are sequentially created such that each subsequent tree is trained to reduce the errors of the previous decision tree. Each tree learns from its predecessors and updates the residual errors. The decision tree that grows next will learn from an updated version of the residuals. Bagging allows the averaging of all such decision learners. Of course, these are but a few techniques that may be utilized for generating the supplemented training data, as other certainly may be used.

In one embodiment, multiple targets may be selected to be learned simultaneously. One or more ML models with multiple outputs or one or more ML models that share some parameters may be trained using architectures similar to those used for training on numerical values or strings. In another embodiment, multiple targets may be learned as a structured output, where the output involves predicting structured outputs, such as paired items. Such targets may be derived from structured-output support vector machines and/or other appropriate ML models. In another embodiment, some of the outputs may be time-series data involving a prediction over various time windows, where each ML model is learning the time series output as a set and not as individual independent outputs. In another embodiment, some of the outputs may be individual or may be groups of independent or structured outputs that predict distribution of incoming money (e.g., deposits, transfers, or other transactions in which money is moved or transacted into an account) in various spending categories.

Once the ML model architecture (or simply the ML model) is chosen, the appropriate model parameters are initialized. In one embodiment, the ML model(s) may be initialized with random values for the parameters, or from parameter values from similar ML model architectures that were trained on different datasets. The method 200 then continues to step 230.

In step 230, at least one ML model is trained. In one embodiment, supervised training is used to train one or more of the ML model(s), which may include adjusting the model parameters to minimize the differences between the predicted target(s) and actual value(s) that serve as the ground truth. Additionally, or alternatively, one or more of the ML model(s) may be trained using unsupervised training techniques. Furthermore, in one embodiment, one or more ML models may be enhanced using, but not limited to, optimization models and techniques to improve further on the accuracy and performance of the one or more ML models. These optimization models and techniques may include the Genetic Algorithm, Simulated Annealing, linear programming, and all their sub components. In one embodiment, a first ML model, which may be a classification model, is trained on missing values from the transactions, which may be the merchant name, for example. The merchant name may be encoded as a numerical value (e.g., one merchant may be represented as “12”, another merchant may be represented as “2”). The classification output of this first ML model is utilized to fill in missing information from the transactional data so as to generate supplemented training data. The supplemented training data (or at least the part of the supplemented training data that has been updated or filled-in) is then utilized as input by a second ML model, which may be a ML continuous model, to compute a prediction value. The prediction value may be the average spending of the past predetermined number of days, which may be 30 days, for example. When such an embodiment is used in conjunction with the method 100, in step 140, the second ML model may be executed (e.g., by the real-time computer system 34 in response to receiving the indication in step 120) and the first ML model may not be executed at this time as it is used to provide the supplemented training data for use in training the second ML model. In other embodiments, the second ML model is trained separately from the first ML model to produce a first trained ML model and a second trained ML model, each of which may be executed as a part of the step 140 of the method 100 to generate the ML model output. Accordingly, in at least one of such embodiments, the ML model output may be based on output of more than one trained ML model.

In at least one embodiment, in steps 230-250, and beginning with step 230, the training process is performed in an iterative fashion. In many embodiments, this training process involves many training iterations in which the model parameters are adjusted to minimize the loss using a loss function. At each iteration of the training, the loss between the predicted and true values is computed. The training continues until the loss is lower than predetermined threshold value or when the loss does not improve after a fixed number of iterations. As shown in step 240, the performance of the at least one trained ML model is evaluated based on the loss function. Each of the trained ML model(s) may be trained using a different loss function. According to some embodiments, other common ML metrics, such as precision, recall, and accuracy, may be used.

Once the performance is evaluated in step 240, step 250 may be carried out in which a feature importance analysis is carried out. In some embodiments, step 250 may be omitted. In step 250, the feature importance analysis may be used to give insight about important features for one or more of the at least one ML model. For each of such ML models, some features are removed, and the prediction performance is evaluated again as a part of another iteration of the training process, which is represented in FIG. 3 by the line that proceeds from step 250 and back to step 230. In one embodiment, the change in prediction accuracy from a first iteration to a second iteration reflects the accuracy contributed by the removed features. In at least some embodiments, as a result of the above-described steps and once the feature importance analysis is completed, at least one or more candidate ML models are obtained. Each such candidate ML model may have different performance characteristics. The method 200 continues to step 260.

In step 260, the best candidate ML models are chosen as the at least one trained models. In one embodiment, the at least one trained models include a trained ML continuous model and a trained ML classification model. Among all the candidate ML continuous models, the model that has the best performance is chosen as the trained ML continuous model. In one embodiment, each of the candidate ML continuous models are a candidate ML regression model; of course, other types of ML continuous models may be used, such as ML RNN models. Among all the candidate ML classification models, the one that has the best performance is chosen as the trained ML classification model. The best performance may be measured by evaluating each of the candidate ML models using the evaluation data and according to known techniques in the art. The chosen models, including the model parameters or weights for each feature, are then saved to memory. The method 200 then ends. And, in at least one embodiment where the method 200 is used as the step 110 of the method 100, the method 100 continues to step 120.

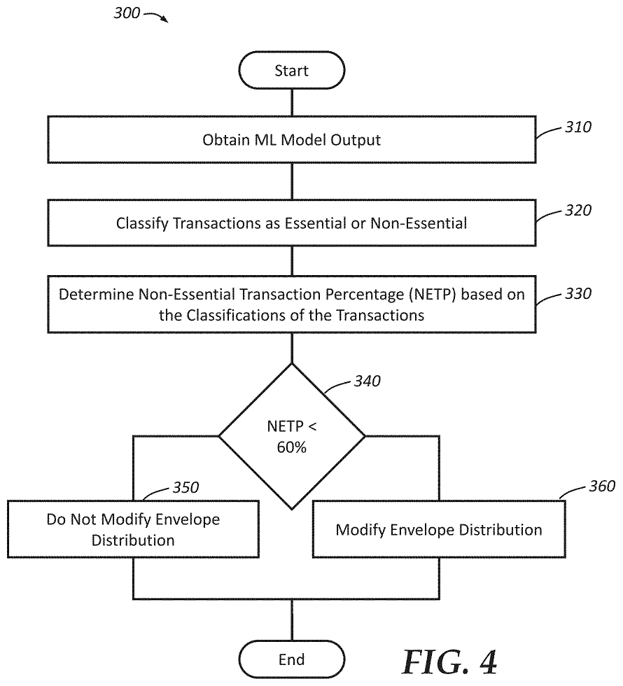

With reference to FIG. 4, there is shown a method 300 of determining an electronic envelope distribution based on a ML model output. The method 300 may be used as a part of the step 140 of the method 100 (FIG. 1). In one embodiment, the method 300 is carried out by the real-time computer system 34. However, in other embodiments, one or more of the steps of the method 300 may be carried out by one or more other systems or components, including, but not limited to, one or more of those other systems or components described above. Further, in an embodiment, the method 300 may be an entirely or at least partially autonomous process performed without any input or involvement on the part of the user or others.

The method 300 provides an embodiment of applying one or more rules in order to modify the ML model output so as to determine the electronic envelope distribution. In the particular embodiment described below, the rule(s) include analyzing past spending behavior of the user of the client account and, specifically, include determining whether a non-essential transaction percentage of transactions of the user within the last predetermined number of days (e.g., 30 days) is less than a predetermined threshold amount, which is illustrated as 60% in the particular embodiment described below, though other percentages may certainly be used. Of course, in other embodiments, one or more other rules may be used in addition to and/or instead of those describe above. For example, the other rule(s) may include determining whether a user's expected expenses for the next 30 days (or other predetermined time period) exceed the amount of a particular electronic envelope, such as a long-term savings electronic envelope or the vault electronic envelope.

The method 300 begins with step 310, wherein the ML model output is obtained. The ML model output may be obtained as a result of step 130 of the method 100 (FIG. 1). In one embodiment, the ML model output is obtained directly from the computer that carried out step 130. In another embodiment, the ML model output is obtained from the storage system 36. Although this step is shown as being carried out before steps 320-340, in another embodiment, this step may be carried out at a different time, such as during step 350 or step 360. In an embodiment, some or all of the functionality described above with respect to step 310 may be performed autonomously and without any input or involvement on the part of the user or others. The method 300 continues to step 320.

In step 320, a plurality of transactions are classified into a first group or a second group. In one embodiment, the first group includes those transactions that are deemed essential and the second group includes those transactions that are deemed non-essential. Of course, in other embodiments, other types of groupings may be used. A transaction is considered essential if the transaction is considered a necessary expense, such as the purchase of necessary goods, the purchase of necessary goods, and required payments (e.g., taxes). A transaction is considered non-essential if the transaction is not an essential transaction. In one embodiment, whether a transaction is deemed essential is based on category information that is associated with the transaction, which may be retrieved from one or more other systems or components. In one embodiment, this category information may be learned based on feedback from users such as that which is used by the Mint™ Categorization Engine operated by Mint™. The plurality of transactions may be transactions in which an outgoing payment is made by the user and may form a part of the user's transactional history, which may be represented by transactional data. The transactional data representing the plurality of transactions may be obtained from the financial services system 22.

In one embodiment, the classification of the plurality of transactions is made based on merchant information that is associated with the plurality of transactions. For example, the transactional data representing the plurality of transactions include a merchant identifier for each transaction and this merchant identifier may be used to obtain other merchant information, such as a merchant type or category (e.g., grocery, utilities, entertainment). The merchant type or category may then be used to classify the transaction as either essential or non-essential. In one embodiment, the plurality of transactions include transactions that were effected in the past X number of days, where X may be any predetermined value, such as 30 or 60. In an embodiment, some or all of the functionality described above with respect to step 320 may be performed autonomously and without any input or involvement on the part of the user or others. The method 300 continues to step 330.

In steps 330-340, a rule is carried out on the grouped transactions. In one embodiment, the rule includes determining a non-essential transaction percentage (NETP) based on the classifications of the plurality of transactions (step 330) and then determining whether the NETP exceeds a particular threshold value (step 340). The non-essential transaction percentage is the percentage of transactions that are classified as non-essential. For example, if there are 100 transactions that are classified and 73 transactions are classified as non-essential, then the non-essential transaction percentage is 73%. The method then proceeds to step 340, where the non-essential transaction percentage is then compared to a predetermined threshold value, which is 60% in the illustrated embodiment. When the non-essential transaction percentage is less than the predetermined threshold value, the method 300 continues to step 350. Otherwise, when the non-essential transaction percentage is greater than or equal to the predetermined threshold value, the method 300 continues to step 360. Of course, in other embodiments, other rules may be applied and, based on the output of applying those rules, the method 300 may proceed to either step 350 or step 360. In an embodiment, some or all of the functionality described above with respect to step 340 may be performed autonomously and without any input or involvement on the part of the user or others.

In step 350, the electronic envelope distribution is not modified and the ML model output is used as the electronic envelope distribution. In step 360, however, the electronic envelope distribution is modified in which the amount of the deposit fund that is to allocated to at least one electronic envelope is modified. For example, in one embodiment, the ML model output may indicate that 30% of the amount of the deposit is to be allocated to a first electronic envelope (e.g., a “Cash” electronic envelope), 20% of the amount of the deposit is to be allocated to a second electronic envelope (e.g., the vault electronic envelope), and 10% of the amount of the deposit is to be allocated to a third electronic envelope (e.g., the emergency electronic envelope). This distribution of the amount of the deposit may be modified for at least one of the first, second, and third electronic envelopes. For example, the percent to be allocated to the first electronic envelope may be reduced by 15%, the percent to be allocated to the second electronic envelope may be increased by 7.5%, and the percent to be allocated to the third electronic envelope may be increased by 7.5%. These changes (e.g., −15%, +7.5%, +7.5%) may be predetermined values that are stored in memory, or may be based on a calculation that is carried out during the method 300, such as during when step 350 is carried out. In an embodiment, some or all of the functionality described above with respect to step 360 may be performed autonomously and without any input or involvement on the part of the user or others. The method 300 then ends. And, in at least one embodiment where the method 300 is used as the step 140 of the method 100, the method 100 continues to step 150.

Customizable Envelopes. Another aspect of the disclosure provides programmable electronic bank envelopes that can be customized by the user, institution, advisor (i.e. authorized party) or automatically (e.g. adaptively) in order to provide, for example, custom electronic envelopes to create savings algorithms and various triggers for their accounts to control transfers, allocation and reallocation of funds into and out of the various envelopes at specific or programmable times or time intervals. This includes the custom naming and creation of the various envelopes, setting timing on the envelopes (e.g. to expire, to be created, to be renamed as a function of time or event, to transfer funds into other envelopes including one time and scheduled transfers), create a hierarchy within envelopes, and setting/attaching specific executable algorithms (programs/code) to the account, including the envelopes in order to control all these features. In one embodiment, the user provides an initial set of envelopes and their names through the client device 24 through the GUI, potentially through a dropdown menu that provides a set of envelopes. In another embodiment, the user updates the set of envelopes using the GUI. In yet another embodiment, the user may select to split an existing envelope into one or more envelopes, by selecting bank transactions that should be grouped into the envelope. Using clustering algorithms or other ML models, based on the transaction features, the system autonomously derives how transactions will be mapped to these envelopes.

Spending Amount. In some embodiments, the core backend system 18 (or other system(s) or component(s)) may be used to assist with spending by the user. In at least some embodiments, the plurality of electronic envelopes may include an electronic envelope for indicating a total spending amount of the user. This electronic envelope, which is referred to as a cash electronic envelope (which may be the same or different from the cash electronic envelope discussed above), is used to indicate an amount of money that may be spent by the user without impacting the balances of the other envelopes or the goals associated with those envelopes. In one embodiment, portions of deposits that are not otherwise allocated to other electronic envelopes may be allocated to the cash electronic envelope and this amount or balance of the cash electronic envelope is referred to as the total spending amount. The total spending amount may be presented to the user via the GUI of the client application 26 and/or the electronic display of the digital display card 40. The total spending amount may be used to determine a daily spending amount or other period-specific spending amount, such as a weekly spending amount. The discussion below refers to updating and utilizing a spending amount, which may be the total spending amount and/or one or more period-specific spending amounts, such as a daily spending amount or weekly spending amount. It should be appreciated that the discussion below that refers to the “spending amount” applies to the total spending amount and one or more period-specific spending amounts.

According to at least one embodiment, the spending amount may be adjusted based on receiving an indication of one or more transactions (e.g., deposit, withdrawal) of one or more bank accounts of the user. In one embodiment, the core backend system 18 updates the spending amount in response to receiving an indication of one or more transactions. In another embodiment, the core backend system 18 updates the spending amount periodically according to a predetermined period, such as, for example, every week or day. In embodiments where the spending amount is updated periodically, the core backend system 18 may retrieve or otherwise obtain any one or more (including all) of the transactions of the user's bank account(s) that have occurred since the last update from, for example, the financial services system 22. These obtained transaction(s) may then be used as a basis for updating the spending amount.

In one embodiment, the spending amount may be updated using one or more rules, which may be applied in the same (or at least in a similar) manner to that described above with respect to the method 300. In another embodiment, one or more trained ML models, including any one or more of those trained ML models described above, may be used to update the spending limit. For example, a trained ML model may take transactional data regarding the one or more obtained transactions as input and then generate a prediction value (or other ML model output) that is then used as (or as a basis for determining) a spending amount or an amount to be allocated to or from the cash electronic envelope.

In one embodiment, one or more rules may be applied to the spending amount to ensure that it is below a spending upper limit and/or above a spending lower limit. In one embodiment, these limits may be set by the user through use of the client application 26 or, in another embodiment, may be set based on a ML model output of one or more trained ML models. In one embodiment, a combination of one or more trained ML models and one or more rules may be used to determine the spending amount. For example, the trained ML model(s) may determine a spending amount value and, then, one or more rules may be applied to ensure that the spending amount value is below the spending upper limit and/or above the spending lower limit. If the spending amount value is within these limits, then the spending amount value is used as the spending amount; otherwise, the spending amount may be adjusted to the spending upper limit (if the spending amount value was over the spending upper limit) or the spending lower limit (if the spending amount value was below the spending lower limit).

When it is determined to update the spending amount, amounts from one or more other electronic envelopes may be taken and provided to the cash electronic envelope, or amounts from the cash electronic envelope may be taken and provided to one or more other electronic envelopes. These amounts may be specified as the result of applying one or more rules to the amount of the transaction and/or based on the ML model output. The application of the one or more rules and/or the ML model output may also indicate the changes in balances of the electronic envelopes, which may inform the system what amounts should be taken from which electronic envelopes and what amounts should be provided to which electronic envelopes. In one embodiment, the trained ML model(s) that is/are used to determine whether and/or the extent to which to update the cash electronic envelope may also use historical electronic envelope data that indicates whether the user overspent or underspent amounts of the cash electronic envelope in a given time period—this is referred to as the amount of overspending/underspending. For example, this historical electronic envelope data may be used as input into the trained ML model(s) as a part of the data preprocessing as described above with respect to step 210.

The spending amount and the amount of overspending/underspending may be periodically computed and used as a part of the training data that is used to train one or more ML models. In such embodiments, this training data may be used to predict the user's overspending/underspending at times in the future, and/or may be used to predict other users' overspending/underspending at times in the future, such as those other users that are a part of the same or common demographic group of the user. These predicted values, which represent a predicted overspending amount or underspending amount, may be used to evaluate the ML model output as it relates to the electronic envelope distribution and/or may be used to provide a basis or starting point for determining the electronic envelope distribution for a new user.

In an embodiment, some or all of the functionality described above with respect to updating or adjusting the spending amount may be performed autonomously and without any input or involvement on the part of the user or others.

User Control of Allocation/Reallocation. While the system and method described above may be autonomous, in some embodiments, the user is allowed opportunities to fine-tune the system and method. This type of fine-tuning is referred to herein as the “AI Drive Mode”. According to one embodiment, the core backend system 18 (or other system(s) or component(s)) may be used to allow the user to exert control over allocation of the amounts of one or more of the plurality of electronic envelopes. In one embodiment, the user may request more favorable allocation for a particular electronic envelope, which may be taken into consideration when allocating an amount of a deposit or reallocating amounts already in the electronic envelopes. This request, which is an example of a user allocation request, may be provided by the user at the client device 24, such as through a GUI provided by the client application 26. As used herein, a user allocation request is a request received from the user that indicates user allocation data, which is data indicating a preference relating to the electronic envelope distribution. The user allocation data may specify a mode of a plurality of selectable modes (as discussed below), may specify whether a particular electronic envelope is favorable or unfavorable (i.e., whether amounts should be allocated more or less favorably to an electronic envelope), and/or may specify other information to be used as a part of determining the electronic envelope distribution. The user allocation request may then be sent to the client interface system 28 of the core backend system 18. In one embodiment, the user allocation request may be used as a part of applying one or more rules to adjust or modify the amount of one or more electronic envelopes that is indicated by the ML model output, as described above with respect to the method 300. In another embodiment, the user allocation request may be used for indicating certain inputs of the trained ML model when executed. And, in one embodiment, a combination of rule(s) and trained ML model(s) may be used to determine or adjust the spending amount, which may include determining a portion of the spending amount that is to be allocated to one or more other electronic envelopes. Furthermore, in some embodiments, the rule(s) and/or trained ML model(s) may take various data as input when making such determinations, such as a user's history of vacations, income, savings, aggregate datasets (e.g., climate, events, news and emotional triggers), etc.

In one embodiment, the GUI may provide a plurality of different modes that may be selectable by the user. For example, the plurality of modes may include one or a combination of the following modes: “Vacation”, “Light”, “Balanced”, “Ultra-Save”, and “Beast”. Based on which mode is selected by the user, and which is indicated by the user allocation request, the amount of the cash electronic envelope (or other electronic envelopes) may be adjusted. As one example, a predetermined percentage may be assigned to each of the modes, such as 100% for the “Vacation” mode, 80% for the “Light” mode, 70% for the “Balanced” mode, 60% for the “Ultra-Save” mode, and 50% for the “Beast” mode. As shown below, Equation (1) may then be applied to calculate an amount to move from the cash electronic envelope to another electronic envelope, such as the long-term savings electronic envelope.

M=(1−P)×Cash Balance (1)

where “P” is the predetermined percentage (e.g., 70% is represented as 0.7), “M” is the amount to move from the cash electronic envelope to a savings envelope (e.g., the long-term savings electronic envelope), and “Cash Balance” is the balance of the cash electronic envelope. In other embodiments, one or more other electronic envelopes may be used in addition to or instead of the cash electronic envelope. In another embodiment, the plurality of modes may include less than all of the modes identified above. Also, in one embodiment, one of the modes may correspond to a mode in which the electronic envelope distribution is not modified, which may be referred to as an “autopilot” mode.

In one embodiment, rather than allocating amounts of a deposit into different electronic envelopes in response to an indication of the deposit, the amounts of the electronic envelopes may be redistributed autonomously among the electronic envelopes. Such an embodiment may be useful, for example, when an indication of a withdrawal is received, such as an indication that an essential purchase with an unexpectedly large price was made. For example, when the user makes such a purchase and an indication is received at the core backend system 18, amounts may be taken from the cash electronic envelope and redistributed/reallocated to an expenses electronic envelope so as to accommodate other expenses that the user is expected to make, such as recurring utility expenses. Of course, this is but one example.

In another embodiment, such a process where amounts of the electronic envelopes may be redistributed among the electronic envelopes (referred to as a reallocation process) may be autonomously carried out periodically according to a predetermined interval (e.g., 1 week) so that the amounts of the electronic envelopes are reallocated periodically to, for example, reflect the financial health of the user. In one embodiment, the user may use the client application 26 to set or update this predetermined interval. In at least some embodiments, the reallocation process may be additionally or alternatively carried out manually in that the user may use the client application 26 to select a manual reallocate command that, when selected, causes a signal to be sent from the client device 24 to the core backend system 18. This manual reallocate command may then cause the core backend system 18 to carry out steps 130-160 of the method 100 with using amounts of the electronic envelopes or other transactional data as input into the trained ML model(s) so as to generate a ML model output that may be used as the basis for the electronic envelope distribution. In such an embodiment, this electronic envelope distribution indicates how to reallocate the amounts between two or more of the electronic envelops. Accordingly, this electronic envelope distribution may then be used to reallocate amounts between the electronic envelopes and, in some embodiments, to cause transfers to be made between the user's associated bank accounts so that the balance of the bank accounts reflects the amounts of the electronic envelopes after the reallocation. In another embodiment, the AI Drive Mode is autonomously calibrated using machine learning models to re-tune the reallocation process based on the user prior responses to such re-tuning.

Spending Stability Factor. In one embodiment, a spending stability factor of the user is determined and this spending stability factor may be used to determine or adjust the electronic envelope distribution. The spending stability factor refers to a confidence in being able to predict periodic expenses of the user, and may be represented, for example, as a number between 0 and 1, with 1 being very predictable (highest confidence) and 0 being very unpredictable (lowest confidence). And, in another embodiment, the spending stability factor indicates a particular group of a plurality of groups, such as a “predictable” group or an “unpredictable” group. The spending stability factor may be determined through analysis of a user's expenses and spending over the course of a predetermined amount of time. For example, the spending stability factor may be determined based on a predicted spending amount. In some embodiments, this predicted spending amount may be determined based on a ML model output of one or more trained ML models. And, in one embodiment these trained ML model(s) may take an average spending over a predetermined period of time (e.g., the past 30 days) of the user as input when determining the predicted spending amount.

In one embodiment, one or more trained ML model(s) may be used to determine the spending stability factor. These trained ML model(s) may take the predicted spending amount as input when determining the spending stability factor, and the ML model output may be a confidence score, such as a value between 0 and 1. These trained ML model(s) may be trained using transactional data particular to the user and/or demographic group(s) of the user, as discussed above. And, in one embodiment, these trained ML model(s) may use transactional data of the user as input when being executed to determine the spending stability factor.

In another embodiment, rule(s) may be used to determine the spending stability factor. For example, the standard deviation of the user's expense history may be taken on a monthly basis. If the standard deviation changes more than a predetermined amount compared to that of the last month, then the spending stability factor may be set to the “unpredictable” group (in embodiments where groupings are used for the spending stability factor). When the spending stability factor is in the “unpredictable” group, then the electronic envelope distribution may be more conservative. For example, the cash electronic envelope amount may be decreased by 15%, while the vault electronic envelope and emergency electronic envelope are each increased by 7.5%. In yet another embodiment, a combination of rule(s) and trained ML model(s) may be used to determine the spending stability factor. Computing the spending stability factor is an autonomous process. In one embodiment, this computation is updated in real-time with no or limited guidance from the user. In another embodiment, this computation is scheduled at regular intervals or as a response to an incoming bank transaction.

Financial Health Score. In some embodiments, the core backend system 18 (or other system(s) or component(s)) may be used to provide feedback to the user regarding spending activities, financial health, and/or money management. In one embodiment, a financial health score is determined and maintained for the user and updated based on certain rules associated with the electronic envelopes of the user. In at least one embodiment, the financial health score may be used to indicate the financial health of the user, such as whether the user is fiscally responsible. For example, at the end of the day, if the percentage of the remaining daily spending amount is within a first percentage range (e.g., 75-100%), the financial health score of the user is increased by a predetermined amount associated with the first percentage range. For example, a financial health score of 174 points may be decreased by 45 points. And, as another example, at the end of the day, if the percentage of the remaining daily spending amount is less than the lower limit of the first percentage range (e.g., 75%) but greater than or equal to the lower limit of a second percentage range (e.g., 50%), the financial health score of the user is increased by a predetermined amount associated with the second percentage range. For example, a financial health score of 174 points may be increased by 31 points. Similar rule(s) may be used and applied to a weekly spending amount and/or a monthly spending amount. In one embodiment, a financial health score may be determined for a particular time period (e.g., day, week, month) and then may aggregated (e.g., averaged) to obtain an overall financial health score. In one embodiment, any one or more of the financial health scores may be computed by the core backend system 18 and then sent to the client device 24, where the financial health score(s) may then be visually presented to the user via the client application 26.

In one embodiment, any one or more of the predetermined values (e.g., the first percentage range, the second percentage range, the scores associated with those percentage ranges) used as a part of the financial health rule(s) (i.e., the rule(s) used to determine a financial health score) may be determined through use of one or more trained ML models. In one embodiment, theses trained ML model(s) are trained using transactional data that is specific to the user or demographic group(s) of the user, which may allow such predetermined values to be specifically tailored to the user. In other embodiments, it is possible to use machine learning methods to autonomously drive or fine-tune such boundaries, limits, and scoring. In one embodiment, the bounds and limits are learned based on several aspects of the user's spending. Further, the change in score may be adaptive, accounting for the time of the year or to individual circumstances. The bounds and limits calculations and the scoring may be trained to exclude specific expenditures or spending anomalies. In some embodiments, the learning, updates, and fine-tuning occur in real time, either periodically or as triggered by a transaction, thus allowing for autonomous, driverless banking.

In some embodiments, the system has the ability to share the financial health score to third parties. This sharing can be periodic or enabled for specific period(s) of time by the user. Further, the sharing can also be made autonomous, updating the third party with changes as needed. The financial health score can be used as evidence to other parties such as mortgage lenders in regard to an individual's financial reliability. This score may enable the unbanked and underbanked to access sensible credit if they are good with their money. This is particularly applicable to individuals and areas where establishing credit is a very difficult if not impossible endeavor given the socio-economic conditions.

In some embodiments, one or more financial health scores, such as the overall financial health score, may be compared to overall financial health scores of other users. This may include displaying the overall financial health score of the user along with those overall financial health scores of other users on the client application 26, and may include various graphics that present these scores and/or other data derived from these scores, such as an average overall financial health score of a group of users. The group of users may be comprised of, for example, one or more demographic groups of users that includes the user. These demographic groups of users may be based on age, income, gender, geography/location, etc. In one embodiment, the user may indicate which demographic group to use for comparing their overall financial health score to. At least in one embodiment, the user would have to indicate that they would like to opt in to this program/feature. And, in one embodiment, the overall financial health scores of the other users would each be anonymized so as to preserve the identity of those users. In one embodiment, the group of users may be selected by the user, such as by adding “friends” (or other individuals identified by the user to the group), provided that the other users have also opted into this program/feature. The creation of this sharing and the regular updates with others may be performed autonomously and adaptively based on default system settings or user-specified settings.

Financial Spending Patterns. In some embodiments, the core backend system 18 (or other system(s) or component(s)) may be used to generate a financial spending pattern, which is one or more values that indicates how well the user has managed their spending over a particular time period. One or more such spending patterns can be referred to as a “spending DNA”. For example, the financial spending pattern may indicate how well the user has managed their spending over a month (referred to as a “monthly financial spending pattern”), or may indicate how well the user has managed their spending over a day (referred to as a “daily financial spending pattern”). In one embodiment, the daily financial spending pattern is calculated as a percentage of what the user spent daily relative to the daily spending amount. In one embodiment, one or more of the financial spending patterns are used to determine one or more financial health scores or other financial spending patterns. In one embodiment, the values of the financial spending patterns are graphically displayed on the GUI of the client application 26. For example, the values of the financial spending pattern may be displayed as a colored bar (i.e., rectangle) that is sized based on the value(s) of the financial spending pattern and/or that may be colored (e.g., red, amber, green) based on the value(s) of the financial spending pattern. While the patterns are referred to herein as spending patterns, they can also include income and spending patterns. In other embodiments, a summary pattern, in the form of text such as, “frugal”, “on track”, and others, provide feedback to the user regarding their spending patterns.

In other embodiments, the patterns are determined using an autonomous machine learning method that continually learns and updates spending patterns. The inputs or input features of this method may contain specific data learned from historical transactions pertaining to the individual user or from other users. The time interval associated with this data can be all prior such histories, histories specific to a time interval, overlapping time intervals, or other periodic histories. The machine learning method can learn to fine-tune and balance how to consider these histories when calculating the spending DNA. The output of this machine learning method would be a spending pattern, or other similar value(s) or pattern(s) or combinations thereof that showcase the user's financial habits.

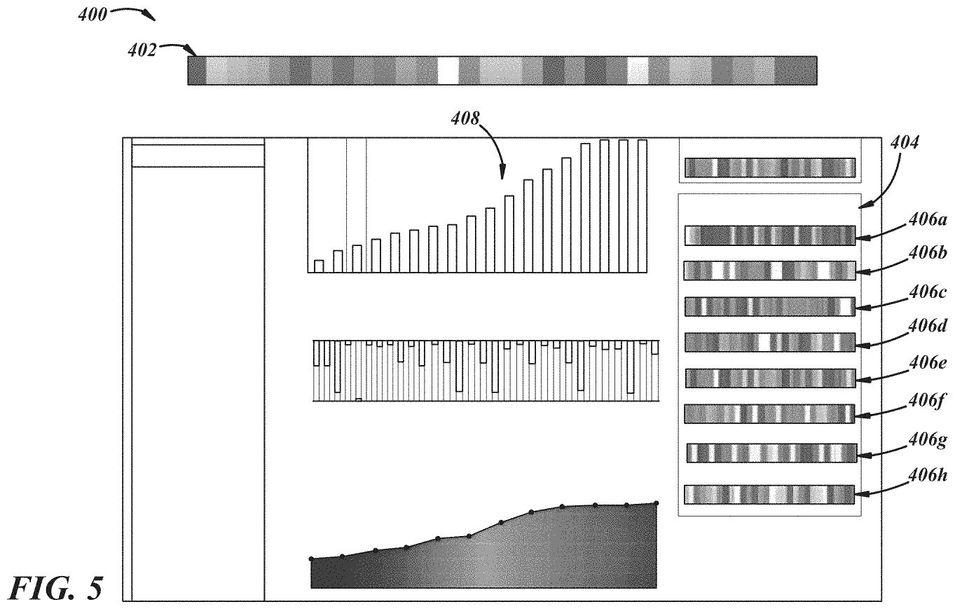

As shown in FIG. 5, the GUI of the client application 26 may depict a screen 400 that indicates one or more financial spending pattern. In particular, the screen 400 includes a bar 402 that is comprised of blocks that indicate a plurality of daily financial spending patterns over the course of a predetermined time interval (e.g., 30 days or a month as shown in FIG. 5). For example, each block of the 30 blocks of the bar 402 indicates whether the daily financial spending score for a particular day is above a first predetermined threshold (e.g., the block may be colored green), below a second predetermined threshold (e.g., the block may be colored red), or between the first and second predetermined thresholds (e.g., the block may be colored amber). The screen 400 may further include a summary section 404 that includes a plurality of graphics 406a-f that indicate a historical summary of the financial spending patterns over the course of a predetermined time period. Each of the graphics 406a-f depict a plurality of blocks that indicate a plurality of financial spending patterns over the course of a predetermined time period (e.g., a month, a week, a year). These graphics 406a-f are similar in nature to the bar 402 and that discussion is incorporated here and applies equally to the graphics 406a-f. Other graphics 408 showing various feedback indicators (e.g., financial health score(s)) may also be provided as shown in FIG. 5. In other embodiments, the financial spending pattern(s) may be visually displayed in different visual forms, such as a wheel or as an animation.

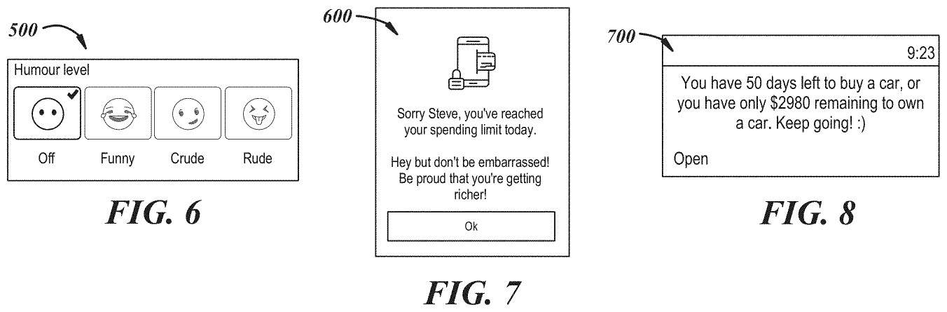

Emotional Triggers. In some embodiments, feedback (including, for example, prompts) may be provided to the user in the form of emotional triggers, which are used to trigger an emotional response from the user so as to cause them to be attentive to one or more aspects of their financial health. In one embodiment, the user may turn on or off this emotional trigger feature and/or configure other settings related to this emotional trigger feature. For example, as shown in FIG. 6, the GUI of the client application 26 may display a screen 500 that allows the user to select a “Humour” (or “Humor”) level that is used as a part of determining one or more characteristics of the emotional triggers that are to be presented to the user. Examples of a humor level include “Funny,” “Crude,” or “Rude”.

In at least some embodiments, the emotional triggers are presented to the user in the form of one or more graphics on the GUI of the client application 26, such as in the form of emoticons. The graphic(s) may be selected from a set of predefined graphics. Alternatively, or additionally, as shown in FIG. 7, the emotional triggers may be in the form of one or more messages 602 that are provided to the user on a screen 600 of the GUI of the client application 26. In one embodiment, the message(s) and/or graphic(s) may be tailored to one or more goals of the user, such as that which is shown on a screen 700 of the GUI of the client application 26 (FIG. 8). The message(s) may be selected from a set of predefined messages. In one embodiment, the graphic(s) and/or message(s) may be generated through use of a deep neural network or other trained ML model, which may be trained based on information relating to the user, including information pertaining to the user's interaction or response to the emotional triggers. These trained ML model(s) may be trained at the core backend system 18 and then executed at the core backend system 18 or at the client device 24, for example.

In one embodiment, the user's interaction or response as a result of viewing the emotional trigger may be monitored by the client application 26, and this information may be captured by the client application 26 as user interaction data. The user interaction data may be used in determining whether to present emotional triggers to the user in the future and/or to determine the content that is used as a part of one or more emotional triggers that are to be presented to the user in the future. The user interaction data may be used to determine whether the user is enjoying the emotional triggers and/or whether the user is responsive to the emotional triggers. These determinations may be made based on whether the user adjusts certain features of the client application 26, such as whether the user increases or decreases a daily spending limit within a predetermined time (e.g., a matter of minutes) after having presented the emotional trigger(s).

In one embodiment, emotional triggers or other messages may be received at the client application 26 from one or more other users. For example, the user may receive a particular message (e.g., a textual message, an emoticon) from another “friend” that congratulates the user on making a fiscally responsible adjustment or having a high financial health score. These types of reinforcement messages are referred to as behavioral reinforcement messages. The user may likewise select a behavioral reinforcement message to be provided to another user, which may then be sent from the client device 24 to the other user's client device.

Fiscal Irresponsibility Alert. In yet another embodiment, a fiscal irresponsibility alert may be provided to the user, such as via the GUI of the client application 26, that indicates that the user may be engaging in fiscally irresponsible behavior. For example, the fiscal irresponsibility alert may be generated in response to determining that the user has made a predetermined number of non-essential purchases in a predetermined time period, such as making a certain number (e.g., 8) of non-essential purchases in a week, and/or may be based on other factors, such as the similarity between multiple non-essential purchases. For example, the fiscal irresponsibility alert may be generated in response to determining that the user has made multiple non-essential purchases that are of the same nature (e.g., same merchant) in a predetermined time period, such as a day or a week. The fiscal irresponsibility alert may be generated by applying one or more rules in a manner similar to that as described above with respect to the method 300. In one embodiment, generating the fiscal irresponsibility alert includes determining whether one or more transactions of bank account(s) of the user are essential or non-essential, which may be carried out as described above with respect to the method 300. This may further include determining whether the transaction(s) adversely affect the financial spending score. This determination may be made using ML model output of one or more trained ML models, such as those discussed above with respect to the financial spending score. The fiscal irresponsibility alert may be presented in the form of one or more textual messages and/or one or more graphics provided on the GUI of the client application 26.

In one embodiment, the fiscal irresponsibility alert may be in the form of a fiscal irresponsibility warning that is generated in anticipation of a transaction (or otherwise before the transaction is made) so that the user may gauge how the transaction, if made, would affect the user's financial health. The user may provide input into the client application 26 indicating details about the transaction, such as the merchant, the product, the services, and/or the purchase amount. These transaction details may then be used by the core backend system 18 and/or the client application 26 to determine how the transaction, if made, would affect the financial spending score(s) or the financial health score(s) of the user. The result of this determination, such as the extent to which the transaction, if made, would affect the financial spending score(s) and/or the financial health score(s) of the user, may then be visually presented to the user via the GUI of the client application 26, for example.

As provided herein, there are multiple modalities of providing the user feedback (including, for example, prompts) on their spending and saving patterns and behavior. The modalities may include but are not limited to the ones mentioned above applied at different time intervals or in response to various transactions. As the described system is autonomous, there are built-in system mechanisms to adjust feedback modalities. In one embodiment, there are opportunities for the user to provide some guidance to adjust said feedback through the GUI interface. In another embodiment, conservational AI systems that utilize natural language processing may be used to customize this feedback and interaction. In another embodiment, sentiment analysis techniques can be applied to the user responsiveness to the various feedback mechanisms to adjust the feedback modalities. In another embodiment, the behavioral reinforcement can be communicated through third parties at the discretion of the user. These types of adjustments may be performed autonomously, without any input or involvement on the part of the user or others, or at set intervals, or as requested by the user or others.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more elements or other items, are each to be construed as open-ended, meaning that the listing is not to be considered as excluding other, additional elements or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of compartmentalizing a monetary transaction into at least one of a plurality of electronic envelopes of an account, comprising:
generating at least one trained machine learning (ML) model by training at least one ML model with training data;
receiving an indication of a deposit into a bank account of a user;
in response to receiving the indication of the deposit into the bank account, generating a ML model output by executing one or more of the at least one trained ML model, wherein the ML model output is used to determine an electronic envelope distribution to be applied to an amount of the deposit;
allocating the amount of the deposit into the at least one electronic envelope of the plurality of electronic envelopes based on the electronic envelope distribution; and
sending electronic envelope account information to a client application that is executed on a client device, wherein the client application is configured to visually display the electronic envelope account information on the client device, and wherein the electronic envelope account information indicates a balance of each of the at least one electronic envelope after having allocated the amount of the deposit.

2. The method of claim 1, wherein a first one of the at least one ML model is trained using time series data that corresponds to transactional data of a plurality of users.

3. The method of claim 1, wherein the at least one ML model includes a first ML model and a second ML model, and wherein the generating step includes training the first ML model and the second ML model to obtain a first trained ML model and a second trained ML model.

4. The method of claim 3, wherein the first ML model is a ML classification model that is generated based on merchant information that is associated with transactional data of the user of the client device, and wherein the ML classification model is used to generate supplemented training data used to train the second ML model.

5. The method of claim 3, wherein the second ML model is a ML continuous model that is generated based on a spending value specifically pertaining to the user of the client device.

6. The method of claim 5, wherein the spending value represents an amount of spending by the user over a predetermined period of time.

7. The method of claim 5, wherein the generating the ML model output step includes executing the second trained ML model but not the first trained ML model.

8. The method of claim 1, wherein the training data includes transactional data that is specific to the user of the client device or a demographic group of users that includes the user.

9. The method of claim 8, wherein the training data includes transactional data that is specific to the demographic group of users, and wherein the demographic group of users includes a plurality of users that are a part of a common income class or a common geographic class.

10. The method of claim 1, wherein deposit information is passed as input into the one or more trained ML models as a part of applying the one or more trained ML models so as to generate the ML model output.

11. The method of claim 1, wherein the method further comprises the step of receiving user allocation data from the client device of the user, and wherein the electronic envelope distribution is based on the ML model output and the user allocation data.

12. The method of claim 1, further comprising the step of applying one or more rules to the amount of the deposit after the step of generating the ML model output and before the step of allocating the amount of the deposit, wherein the one or more rules are used along with the ML model output to determine the electronic envelope distribution.

13. The method of claim 12, wherein a first rule of the one or more rules includes analyzing past spending behavior of the user of the client account.

14. The method of claim 1, wherein the at least one electronic envelope includes two or more electronic envelopes.

15. The method of claim 1, wherein each of the electronic envelopes is associated with a bank account.

16. The method of claim 1, wherein the method further comprises the step of determining a financial health score of the user based on amounts of at least one of the plurality of electronic envelopes.

17. The method of claim 1, wherein the method further comprises the step of determining a financial spending pattern of the user based on amounts of at least one of the plurality of electronic envelopes.

18. The method of claim 1, wherein the method further comprises the step of determining one or more emotional triggers to present to the user at the client device based on transactional data of the user.

19. The method of claim 1, wherein the method further comprises the step of determining a spending stability factor of the user, and wherein the electronic envelope distribution is modified based on the spending stability factor of the user.

20. An electronic envelope compartmentalization system, comprising:
one or more electronic processors;
one or more electronic memories each electrically connected to at least one of the one or more processors and having instructions stored therein;
wherein the one or more electronic processors are configured to access the one or more electronic memories and execute the instructions stored therein such that the one or more electronic processors are configured to:
generate at least one trained machine learning (ML) model by training at least one ML model with training data;
receive an indication of a deposit into a bank account of a user;
in response to receiving the indication of the deposit into the bank account, generate a ML model output by executing one or more of the at least one trained ML model, wherein the ML model output is used to determine an electronic envelope distribution to be applied to an amount of the deposit;
allocate the amount of the deposit into the at least one electronic envelope of the plurality of electronic envelopes based on the electronic envelope distribution; and
cause electronic envelope account information to be sent to a client application that is executed on a client device, wherein the client application is configured to visually display the electronic envelope account information on the client device, and wherein the electronic envelope account information indicates a balance of each of the at least one electronic envelope after having allocated the amount of the deposit.
